(19) United States
(12) Patent Application Publication
(10) Pub. No.: US 2026/0119810 A1
(43) Pub. Date: Apr. 30, 2026

(54) TRIVIA GENERATION

(71) Applicant: Roku, Inc., San Jose, CA (US)

(72) Inventor: Habib Ali Virji, South Croydon (GB)

(73) Assignee: Roku, Inc., San Jose, CA (US)

(21) Appl. No.: 18/927,539

(22) Filed: Oct. 25, 2024

(51) Int. Cl. G06F 40/40; A63F 13/60; G06F 16/33

(52) U.S. Cl. CPC G06F 40/40; A63F 13/60; G06F 16/3344

(57) ABSTRACT

Disclosed herein are system, apparatus, device, method and/or computer program product aspects, and/or combinations and sub-combinations thereof, for using large language models and text embedding models to generate trivia questions. An example aspect operates by a computer-implemented method. The method includes receiving, by at least one computer processor, a category for a plurality of trivia questions and receiving a difficulty level for the plurality of trivia questions. The method further includes using the category to retrieve additional information for the plurality of trivia questions and generating the plurality of trivia questions based at least on the additional information and the difficulty level. The method further includes displaying the plurality of trivia questions on a display device.

### BACKGROUND

### Field

This disclosure is generally directed to methods and systems for generating trivia questions, and more specifically for generating trivia questions using large language models and text embedding models.

### SUMMARY

Provided herein are system, apparatus, article of manufacture, method and/or computer program product aspects, and/or combinations and sub-combinations thereof, for using large language models and text embedding models to generate trivia questions.

An example aspect operates by a computer-implemented method. The method includes receiving, by at least one computer processor, a category for a plurality of trivia questions and receiving a difficulty level for the plurality of trivia questions. The method further includes using the category to retrieve additional information for the plurality of trivia questions and generating the plurality of trivia questions based at least on the additional information and the difficulty level. The method further includes displaying the plurality of trivia questions on a display device.

In some aspects, generating the plurality of trivia questions includes using a large language model (LLM) to generate the plurality of trivia questions based at least on the additional information and the difficulty level.

In some aspects, the method further includes sending a request including the category to a database and retrieving the additional information from the database in response to the request.

In some aspects, the method further includes receiving a first parameter associated with a number of the plurality of trivia questions and a second parameter associated with a type of answers for the plurality of trivia questions. Generating the plurality of trivia questions can include generating the plurality of trivia questions based at least on the additional information, the difficulty level, the first parameter, and the second parameter.

In some aspects, the method further includes generating a content identifier (ID) for the plurality of trivia questions, where the content ID is a unique ID to content associated with the generating the plurality of trivia questions.

In some aspects, the method further includes processing the plurality of trivia questions before displaying the plurality of trivia questions and displaying the processed plurality of trivia questions on the display device. In some aspects, processing the plurality of trivia questions can include at least one of (1) translating the plurality of trivia questions from a first language to a second language, (2) generating additional facts associated with the plurality of trivia questions, (3) examining a grammar of the plurality of trivia questions, or (4) generating a content identifier (ID) for the plurality of trivia questions.

In some aspects, processing the plurality of trivia questions can include generating a vector for a first trivia question of the plurality of trivia questions using a text embedding model and comparing the vector with a plurality of vectors associated with previously generated trivia questions. The processing can further include generating a plurality of similarity values based on the comparison and comparing each one of the plurality of similarity values with a similarity threshold.

In response to each one of the plurality of similarity values being greater than the similarity threshold, the method further includes displaying the first trivia question of the plurality of trivia questions on the display device and storing the vector and the first trivia question of the plurality of trivia questions in a database.

In response to at least one of the plurality of similarity values being less than or equal to the similarity threshold, the method further includes disregarding the first trivia question and generating a new trivia question based at least on the additional information and the difficulty level.

An example aspect operates by a non-transitory computer-readable medium having instructions stored thereon that, when executed by at least one computing device, cause the at least one computing device to perform operations. The operations can include receiving a category for a plurality of trivia questions and receiving a difficulty level for the plurality of trivia questions. The operations further include using the category to retrieve additional information for the plurality of trivia questions and generating the plurality of trivia questions based at least on the additional information and the difficulty level. The operations further include displaying the plurality of trivia questions on a display device.

An example aspect operates by a system including one or more memories and at least one processor each coupled to at least one of the one or more memories. The at least one processor is configured to perform operations including include receiving a category for a plurality of trivia questions and receiving a difficulty level for the plurality of trivia questions. The operations further include using the category to retrieve additional information for the plurality of trivia questions and generating the plurality of trivia questions based at least on the additional information and the difficulty level. The operations further include displaying the plurality of trivia questions on a display device.

### BRIEF DESCRIPTION OF THE FIGURES

The accompanying drawings are incorporated herein and form a part of the specification.

FIG. 1 illustrates a block diagram of a multimedia environment, according to some aspects.

FIG. 2 illustrates a block diagram of a streaming media device, according to some aspects.

FIG. 3 illustrates a block diagram of a trivia generator, according to some aspects.

FIG. 4A illustrates one exemplary method for generating and displaying trivia questions, according to some aspects.

FIG. 4B illustrates one exemplary method for processing trivia questions, according to some aspects.

FIG. 5 illustrates an example computer system that can be used for implementing various aspects.

In the drawings, like reference numbers generally indicate identical or similar elements. Additionally, generally, the left-most digit(s) of a reference number identifies the drawing in which the reference number first appears.

### DETAILED DESCRIPTION

Generating trivia questions requires generating a high volume of questions with high quality. However, the manual generation of trivia questions is not scalable as generating these questions are very time and resource-intensive. Additionally, there is a lack of control for manual trivia generation as it is difficult to control variables such as difficulty level of the questions and it is difficult to avoid repetition of the questions or avoid similar questions. Manually generating trivia questions has additional challenges. For example, it is difficult and time-consuming to generate and add metadata to the questions. Also, manually generating the questions involves high cost of resources.

Provided herein are system, apparatus, article of manufacture, method and/or computer program product aspects, and/or combinations and sub-combinations thereof, for automatically generating trivia questions. For example, system, apparatus, article of manufacture, method and/or computer program product aspects, and/or combinations and sub-combinations thereof are provided for using language models (e.g., large language models (LLMs)) and text embedding models to automatically generate trivia questions.

By using language models (e.g., large language models (LLMs)), trivia questions can be generated automatically. Additionally, options and fun facts can also be generated for the trivia questions using the language models. The difficulty level for the trivia questions can be selected and be used in automatic generation of the trivia questions. By using the text embedding models, the repetition of the trivia questions can be controlled such that same or overly similar questions will not be generated. By using the language models and/or text embedding models, additional features can be added to the trivia question generation. For example, features such as, but not limited to, question regeneration, validation, grammar auto-correction, and the same can be added to the trivia question generation.

By using the language models and/or text embedding models, the trivia generation system of this disclosure can generate high quality and high quantity trivia questions, can avoid duplications, can generate different levels of questions, and can generate required metadata. The trivia generation system, apparatus, article of manufacture, method and/or computer program product aspects, and/or combinations and sub-combinations thereof of this disclosure provide technical solutions and increase efficiencies of computing resources for generating high volume of high quality questions with specific metadata.

Although some aspects of this disclosure are discussed with respect to large language models (LLMs), other computational models that can generate text, translate content, and perform other natural language processing (NLP) tasks can be used. Similarly, although some aspects of this disclosure are discussed with respect to text embedding models, other models to convert words or phrases from text into numerical data can be used.

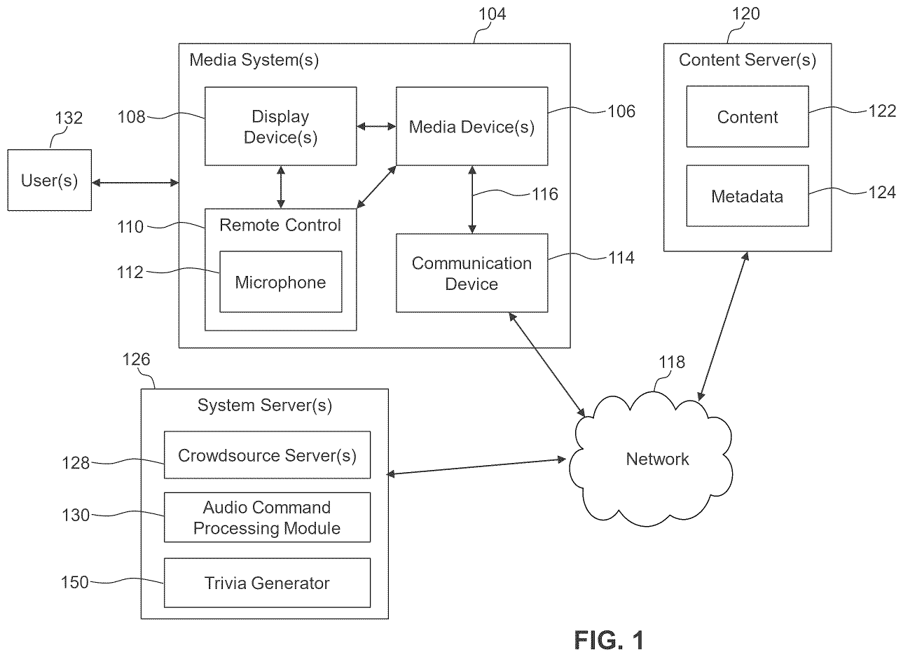

Various aspects of this disclosure may be implemented using and/or may be part of a multimedia environment 102 shown in FIG. 1. It is noted, however, that multimedia environment 102 is provided solely for illustrative purposes, and is not limiting. Aspects of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102 that can include a trivia generation system such as trivia generator 150, according to some aspects. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, smart phone, tablet, wearable (such as a watch or glasses), appliance, internet of things (IoT) device, and/or projector, to name just a few examples. In some aspects, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, where the link 116 may include wireless (such as WiFi) and/or wired connections.

In various aspects, the network 118 can include, without limitation, wired and/or wireless intranet, extranet, Internet, cellular, Bluetooth™, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, a laptop computer, an smartphone, a wearable device, on-screen controls, integrated control buttons, audio controls, or any combination thereof, to name just a few examples. In an aspect, the remote control 110 wirelessly communicates with the media device 106 and/or display device 108 using cellular, Bluetooth™, infrared, etc., or any combination thereof. The remote control 110 may include a microphone 112, which is further described below.

The multimedia environment 102 may include a plurality of content servers 120 (also called content providers, channels or sources 120). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some aspects, metadata 124 includes data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing aspects and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users'viewing experience at particular portions of the movie (for example, when the soundtrack of the movie is difficult to hear), and turning closed captioning off may enhance users'viewing experience at other portions of the movie (for example, when displaying closed captioning obstructs critical visual aspects of the movie). Accordingly, the crowdsource server(s) 128 may operate to cause closed captioning to be automatically turned on and/or off during future streamings of the movie.

The system servers 126 may also include an audio command processing module 130. As noted above, the remote control 110 may include a microphone 112. The microphone 112 may receive audio data from users 132 (as well as other sources, such as the display device 108). In some aspects, the media device 106 may be audio responsive, and the audio data may represent verbal commands from the user 132 to control the media device 106 as well as other components in the media system 104, such as the display device 108.

In some aspects, the audio data received by the microphone 112 in the remote control 110 is transferred to the media device 106, which is then forwarded to the audio command processing module 130 in the system servers 126. The audio command processing module 130 may operate to process and analyze the received audio data to recognize the user 132's verbal command. The audio command processing module 130 may then forward the verbal command back to the media device 106 for processing.

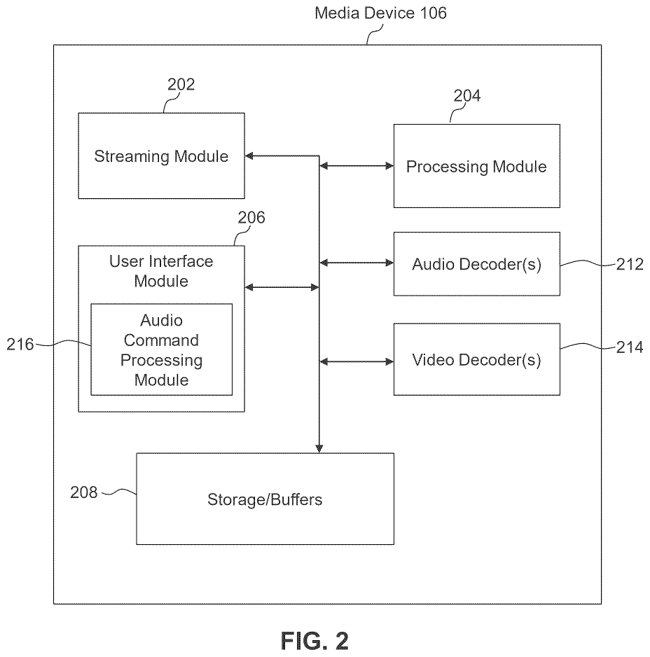

In some aspects, the audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

According to some aspects, the system servers 126 can include the trivia generator 150. The trivia generator 150 is configured to automatically generate trivia questions. For example, the trivia generator 150 is configured to use language models (e.g., LLMs) and text embedding models to automatically generate trivia questions. The trivia generator 150 is further configured to generate options and fun facts associated with the trivia questions using the language models and/or text embedding models. The trivia generator 150 can use a difficulty level for generating the trivia questions. The trivia generator 150 can also control the repetition of the trivia questions such that same or overly similar questions will not be generated. The trivia generator 150 can also add additional features to the trivia question generation. For example, the trivia generator 150 can add features such as, but not limited to, question regeneration, validation, grammar auto-correction, and the same to the trivia question generation. The trivia generator 150 is configured to generate high quality and high quantity trivia questions, avoid duplication, generate different levels of questions, and generate required metadata.

As noted above, although some aspects of this disclosure are discussed with respect to large language models (LLMs), the trivia generator 150 can use other computational models that can generate text, translate content, and perform other natural language processing (NLP) tasks. Similarly, although some aspects of this disclosure are discussed with respect to text embedding models, the trivia generator 150 can use other models to convert words or phrases from text into numerical data.

According to some aspects, the structural and functional aspects of the trivia generator 150 may wholly exist in the system servers 126. Additionally, or alternatively, the structural and functional aspects of the trivia generator 150 may partially exist in the system servers 126. Additionally, or alternatively, the structural and functional aspects of the trivia generator 150 may wholly or partially exist in the media system 104. Additionally, or alternatively, the structural and functional aspects of the trivia generator 150 may wholly or partially exist in the media device 106. Additionally, or alternatively, the structural and functional aspects of the trivia generator 150 may wholly or partially exist in the content servers 120. Additionally, or alternatively, the structural and functional aspects of the trivia generator 150 may wholly or partially exist in one or more of the system servers 126, the media system 104, the media device 106, and the content servers 120. The trivia generator 150 provide technical solutions and increase efficiencies of computing resources for generating high volume of high quality questions with specific metadata.

FIG. 2 illustrates a block diagram of an example media device 106, according to some aspects. Media device 106 may include a streaming module 202, processing module 204, storage/buffers 208, and/or user interface module 206. As described above, the user interface module 206 may include the audio command processing module 216.

The media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OP1a, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some aspects, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 132.

In streaming aspects, the streaming module 202 may transmit the content to the display device 108 in real time or near real time as it receives such content from the content server(s) 120. In non-streaming aspects, the media device 106 may store the content received from content server(s) 120 in storage/buffers 208 for later playback on display device 108.

### The Trivia Generator

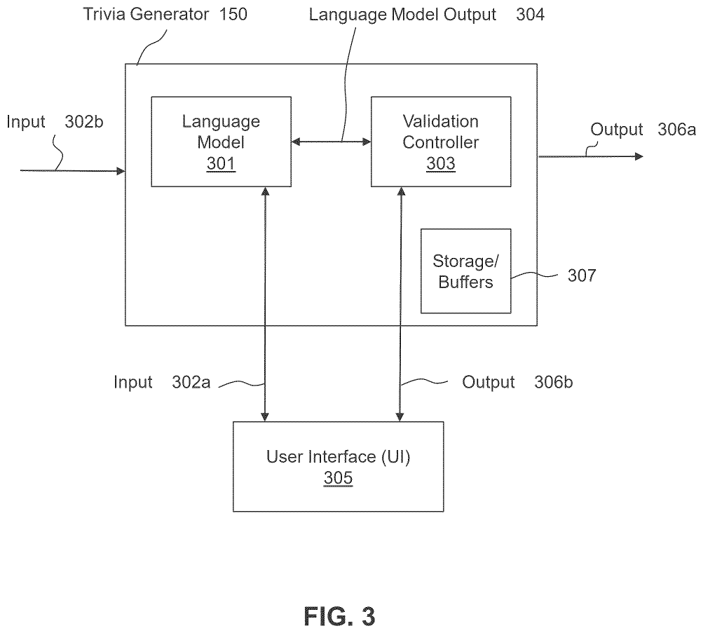

FIG. 3 illustrates a block diagram of an example trivia generator 150, according to some aspects. According to some aspects, the trivia generator 150 can include a language model 301, a validation controller 303, and a storage/buffers 307. However, the aspects of this disclosure are not limited to these examples, and the trivia generator 150 can include other systems and/or modules.

The trivia generator 150 can be coupled to a user interface (UI) 305. According to some aspects, a user can be configured to use the UI 305 to provide an input 302a to the trivia generator 150. Also, the user can use the UI 305 to receive and/or view an output 306b. Additionally, or alternatively, the trivia generator 150 can receive an input 302b and generate an output 306a. As discussed in more detail below, the trivia generator 150 is configured to generate the output 306a based on the input 302a and/or the input 302b. Additionally, or alternatively, the trivia generator 150 is configured to generate the output 306b based on the input 302a and/or the input 302b. In some aspects, the output 306a is the same as the output 306b. In some aspects, the output 306a is different from the output 306b.

According to some aspects, the user can use the UI 305 to initiate the trivia generator 150 to generate trivia questions. Additionally, or alternatively, the trivia generator 150 can be configured to automatically start generating the trivia questions. For example, the trivia generator 150 can be configured to periodically generate the trivia questions based on a predetermined time period. Additionally, or alternatively, the trivia generator 150 can be configured to start generating the trivia questions in accordance with a content being played to one or more users. For example, when one or more users start viewing a content using media device(s) 106, the trivia generator 150 can be configured to generate the trivia questions. According to some aspects, the trivia generator 150 can generate the trivia questions associated with the content being viewed by the one or more users.

However, the aspects of this disclosure are not limited to these examples, and other operations can trigger the trivia generator 150 to generate the trivia questions.

According to some aspects, the trivia generator 150 can receive one or more of the input 302a and/or the input 302b to generate the trivia questions. According to some aspects, the input 302a can include one or more parameters associated with one or more categories for the trivia questions. Additionally, or alternatively, the input 302a can include one or more parameters associated with the number of the trivia questions to be generated by the trivia generator 150. Additionally, or alternatively, the input 302a can include one or more parameters associated with a type of answers for the trivia questions. Additionally, or alternatively, the input 302a can include one or more parameters associated with a difficulty level of the trivia questions to be generated by the trivia generator 150. However, the aspects of this disclosure are not limited to these parameters and other parameters can be used as the input 302a.

According to some aspects, the one or more parameters associated with one or more categories for the trivia questions can indicate the category to be used for the trivia questions. For example, a user can use the UI 305 to select a category for the trivia questions. Additionally, or alternatively, the trivia generator 150 can randomly choose the category for the trivia questions. Additionally, or alternatively, the trivia generator 150 can choose the category for the trivia questions based on a content that a user has chosen. Other methods can also be used for choosing the category of the trivia questions. According to some aspects, the category for the trivia questions can include, but is not limited to, specific movie, specific TV series, specific sports event, popular movies, popular sports, partners, movie lists, or the like.

For example, the specific movie and/or specific TV series categories can be used to generate plot-related and non-plot-related questions for a specific movie or a specific series. According to some aspects, the input 302a can further include an indication for plot-related or non-plot-related for the questions to be generated.

In some aspects, the specific sports event can be used to generate questions related to a specific sports event such as, but not limited to, Olympics, soccer World Cup, NFL, NBA, or the like. In some aspects, the popular movies can be used to generate questions related to popular movies and/or TV series. In some aspects, data from one or more Application Programming Interfaces (APIs) can be used to determine the popular movies and/or TV series. For example, one or more API at system servers 126 can be used to determine the movies and/or TV series that are viewed more than a first threshold.

In some aspects, the popular sports can be used to generate questions related to popular sports. In some aspects, data from one or more APIs can be used to determine the popular sports. For example, one or more API at system servers 126 can be used to determine the sports that are viewed more than a second threshold. The first threshold and the second threshold can be the same in some aspects. The first threshold and the second threshold can be different in some aspects.

In some aspects, partner information can be used to generate questions related to one or more partners. According to some aspects, the partners can include content providers that provide content to the media system 104. The trivia generator 150 can be configured to generate the trivia questions for the specific partner indicated by the input 302a.

In some aspects, partner information can be used to generate questions related to one or more movie lists. For example, one or more movie lists can be stored in storage/buffers 307. The movie list can be based on a user's selected movies, based on genre of movies, based on a specific director's movies, based on a specific actor's movies, or the like. The trivia generator 150 can be configured to generate the trivia questions for the specific movie list indicated by the input 302a.

In addition to, or alternatively to, the one or more parameters associated with one or more categories for the trivia questions, the input 302a can include one or more parameters associated with the number of the trivia questions to be generated by the trivia generator 150. For example, the user of the UI 305 can indicate the number of questions that the trivia generator 150 is to generate. Additionally, or alternatively, the trivia generator 150 can use a default number of questions to generate the trivia questions. In some aspects, the default number of questions can be specific to the category of the questions indicated by the input 302a. In some aspects, the default number of questions can be specific to the content associated with the questions to be generated.

In addition to, or alternatively to, one or more of the category and the number of questions, the input 302a can include one or more parameters associated with a type of answers for the trivia questions. For example, the user of the UI 305 can indicate what type of answers the trivia generator 150 is to generate. For example, the input 302a can indicate that the trivia generator 150 generate a multiple choice answer with 2 choices. In another example, the input 302a can indicate that the trivia generator 150 generate a multiple choice answer with 4 choices. In another example, the input 302a can indicate that the trivia generator 150 generate answers with missing response to be filled in by a user playing the trivia. However, other types of answers can be indicated by the input 302a.

In addition to, or alternatively to, one or more of the category, the number of questions, and the type of answers, the input 302a can include one or more parameters associated with a difficulty level of the trivia questions to be generated by the trivia generator 150. For example, the user of the UI 305 can indicate the difficulty level of the trivia questions to be generated by the trivia generator 150. In some aspects, the difficulty level can include easy, medium, and hard. In some aspects, the difficulty level can be an integer number between 1 and 5, with 1 being the easiest and 5 being the hardest. However, other levels of difficulty can be used as the one or more parameters associated with the difficulty level of the trivia questions.

According to some aspects, the trivia generator 150 is configured to use the received input 302a for receiving and/or retrieving an additional input 302b. The trivia generator 150 is configured to receive and/or retrieve additional information for generating the trivia questions based on the input 302a. The trivia generator 150 receives and/or retrieves the additional information as the input 302b. For example, the trivia generator 150 can use the one or more parameters associated the one or more categories indicated in the input 302a to receive and/or retrieve the additional information as the input 302b.

In one example, the one or more parameters associated with the one or more categories indicates the category as a specific movie to generate the trivia questions for. The language model 301 of the trivia generator 150 receives the category as part of the input 302b. The language model 301 uses the specific movie category to retrieve additional information associated with the specific movie. For example, the language model 301 can access a database that stores the additional information for different content. The language model 301 can send a request to the database. The request can indicate the specific movie that the language model 301 is looking for. The language model 301 can receive the additional information as input 302b from the database. The additional information in the input 302b can include information such as actors'names, director's name, plot information, non-plot information, the year the movie was made, and more information associated with the specific movie. The language model 301 can use the received additional information for generating the trivia questions.

As another example, the one or more parameters associated with the one or more categories indicates the category as a list of popular movies to generate the trivia questions for. The language model 301 of the trivia generator 150 receives the category as part of the input 302b. The language model 301 uses the list of popular movies category to retrieve additional information associated with each movie on the list of popular movies. For example, the language model 301 can access a database that stores the additional information for different content. The language model 301 can send a request to the database. The request can indicate the list of popular movies that the language model 301 is looking for. The language model 301 can receive the additional information as input 302b from the database. The additional information in the input 302b can include information such as actors'names, director's name, plot information, non-plot information, the year the movie was made, and more information associated with each movie on the list of popular movies. The language model 301 can use the received additional information for generating the trivia questions.

Although some examples are discussed above, the language model 301 of the trivia generator 150 can use any one or more parameters in the input 302a to retrieve additional information as the input 302b. The language model 301 can access one or more databases to retrieve the input 302b. The language model 301 can send the one or more parameters in the input 302a or a subset of the one or more parameters in the input 302a to the one or more databases to retrieve the input 302b. According to some aspects, the databases used to retrieve the additional information can located at content servers 120, the system servers 126, and/or other information databases.

The language model 301 uses the information in input 302b and the one or more parameters in input 302a to generate one or more trivia questions. For example, after retrieving the additional information in the input 302b based on the category indicated in the input 302a, the language model 301 generates a number of trivia questions based on the requested number indicated in the input 302a. The language model 301 also generates the one or more trivia questions based on the difficulty level indicated in the input 302a. Also, the language model 301 generates the one or more trivia questions based on the type of answers indicated in the input 302a.

According to some aspects, the language model 301 can include a large language model (LLM). However, the language model 301 can include any other computational models that can generate text, translate content, and perform other natural language processing (NLP) tasks.

According to some aspects, in addition to the first set of one or more trivia questions generated by the language model 301 (a first part of the language model output 304), the language model 301 is configured to generate one or more additional facts associated with one or more of the first set of one or more trivia questions. The language model 301 can generate these additional facts associated with the trivia questions using the additional information in the input 302b. The additional facts can include fun facts that can be displayed with the trivia questions. The language model 301 can output the additional facts as a second part of the language model output 304.

According to some aspects, the first set of one or more trivia questions and/or the additional facts generated by the language model 301 (language model output 304) are input to a validation controller 303. The validation controller 303 can perform additional functions on the language model output 304 (the first set of one or more trivia questions and/or the additional facts generated by the language model 301) before the final set of trivia questions and/or the additional facts are provided as the output 306a and/or the output 306b.

In some aspects, the validation controller 303 can be configured to translate the language model output 304 from a first language to a second language. For example, the language model output 304 are generated in English. The validation controller 303 can be configured to translate the language model output 304 to German before the final set of trivia questions are provided as the output 306a and/or the output 306b. In some aspects, the language to be translated in is indicated in input 302a provided by the user of the UI 305. Additionally, or alternatively, the validation controller 303 can determine the language to translate the language model output 304 based on the language of a content associated with the trivia questions, based on a language associated with a region (e.g., a country) where the trivia questions are being displayed, based on a language detected by, for example, the media device 106 and/or the remote control 110, or the like.

Additionally, or alternatively, the validation controller 303 can be configured to review and revise the language model output 304 for any grammatical errors. For example, the validation controller 303 alone, or in combination with the language model 301, can review the language model output 304 to determine whether any grammatical error exists in the language model output 304. If grammatical errors exist, the validation controller 303 alone, or in combination with the language model 301, can correct the errors in the language model output 304 before the final set of trivia questions are provided as the output 306a and/or the output 306b. In some aspects, the validation controller 303 can perform the grammar check before any translations.

Additionally, or alternatively, the validation controller 303 can be configured to determine whether the language model output 304 includes any duplicate or overly similar questions within the language model output 304 and/or compared to previously generated trivia questions. In some aspects, the validation controller 303 can use text embedding models to determine whether the language model output 304 includes any duplicate or overly similar questions (and/or the additional facts) within the language model output 304 and/or compared to previously generated trivia questions (and/or the additional facts). The validation controller 303 can use other models to convert words or phrases from text into numerical data for determining whether the language model output 304 includes any duplicate or overly similar questions (and/or the additional facts).

According to some aspects, the validation controller 303 can convert the language model output 304 (the first set of one or more trivia questions and/or the additional facts generated by the language model 301) to a set of vectors using, for example, a text embedding model. In an example, the validation controller 303 converts each trivia question string in the language model output 304 into a 3072-dimensional vector to capture the trivia question's semantic meaning. However, other dimension vectors can be used for the conversion. After the conversion, the validation controller 303 can compare the vector of each trivia question with a set of existing vectors. The set of existing vectors can include a set of vectors stored in the storage/buffers 307.

According to some aspects, comparing the vector of each trivia question with the set of vectors can include comparing each component of the vector with the corresponding component of the set of vectors. However, the validation controller 303 can use other methods to compare the vector of each trivia question with the set of vectors.

Based on the comparison, the validation controller 303 can determine whether the vector is similar to one or more vectors in the set of vectors. For example, if the comparison of the vector with one or more vectors in the set of vectors satisfies a condition (e.g., based on a threshold), the validation controller 303 can determine that the vector is similar to one or more vectors in the set of vectors. For example, if the comparison of the vector with one or more vectors in the set of vectors determines that a difference between the vector and one or more vectors in the set of vectors is less than the threshold, the validation controller 303 can determine that the vector is similar to one or more vectors in the set of vectors.

In response to determining that the vector of a trivia question (and/or the additional facts) is similar to one or more vectors in the set of vectors, the validation controller 303 can disregard the trivia question (and/or the additional facts) and send a request to the language model 301 to generate a new trivia question (and/or the additional facts).

In response to determining that the vector of the trivia question is not similar to one or more vectors in the set of vectors, the validation controller 303 output the trivia question (and/or the additional facts-e.g., as output 306a and/or output 306b). Additionally, or alternatively, the validation controller 303 can store the vector of the trivia question (and/or the additional facts) in the storage/buffers 307. Additionally, or alternatively, the validation controller 303 can store the trivia question (and/or the additional facts) in the storage/buffers 307.

In addition to, or alternatively to, language translation, grammar check, and/or similarity check discussed above, the validation controller 303 can be configured to request the language model 301 to re-generate trivia questions (and/or the additional facts). In some aspects, the validation controller 303 (directly or indirectly from the language model 301) can receive a request through, for example, input 302a from the user of the UI 305 to re-generate one or more trivia questions (and/or the additional facts). The validation controller 303 can send a request to the language model 301 to re-generate the one or more trivia questions (and/or the additional facts). The validation controller 303 can send the one or more questions with the request to the language model 301 to re-generate the one or more trivia questions. In some aspects, the language model 301 can directly receive the request to re-generate one or more questions from the UI 305.

In some aspects, the validation controller 303 can determine whether one or more trivia questions satisfy (and/or the additional facts) one or more predetermined conditions. In response to determining that one or more trivia questions (and/or the additional facts) do not satisfy one or more predetermined conditions, the validation controller 303 can send a request to the language model 301 to re-generate these trivia questions (and/or the additional facts). The validation controller 303 can send these trivia questions (and/or the additional facts) with the request to the language model 301 to re-generate these trivia questions. For example, if the trivia questions are being generated for a specific audience (e.g., for kids between 10 and 15 years old), the validation controller 303 can determine whether any of the trivia questions in language model output 304 include language not appropriate for the specific audience. For example, the validation controller 303 can compare the phrases in the trivia questions with a list of phrases (e.g., stored in storage/buffers 307) to determine whether any of the trivia questions in language model output 304 include language not appropriate for the specific audience. The validation controller 303 can use the vector embedding discussed above with respect to similarity check to determine whether any of the first set of trivia questions (and/or the additional facts) in language model output 304 include language not appropriate for the specific audience.

The validation controller 303 can also be configured to generate a content identifier (ID) for the trivia questions (and/or the additional facts). According to some aspects, the content ID is a unique ID specific to the content associated with the set of trivia questions (and/or the additional facts). For example, when a first set of trivia questions are associated with a first specific movie (a first content), the first set of trivia questions will have the same content ID (e.g., a first content ID) associated with the first movie (the first content). When a second set of trivia questions are associated with a second specific movie (a second content), the second set of trivia questions will have the same content ID (e.g., a second content ID) associated with the second movie (the second content).

According to some aspects, the content ID is part of metadata that the validation controller 303 generates for the trivia questions. In addition to the content ID, the validation controller 303 can generate additional data as part of the metadata for the trivia questions. For example, the metadata for each trivia question can further include information associated with the time and the date the trivia question was generated, the difficulty level of the trivia question, the language of the trivia question, and the like. According to some aspects, the trivia generator 150 can use the metadata to link the trivia questions that are related to each other for further processing and/or provision to users. For example, the trivia generator 150 can use the content ID of the trivia questions to link the questions that are associated to the same content. In this case, if a user is requesting trivia questions for a specific content, in addition to, or alternatively to, generating the trivia questions, the trivia generator 150 can use the content ID of existing trivia questions to provide the questions to the user. In another example, the trivia generator 150 can use the language information of the metadata of the trivia questions to link the questions have the same language. In this case, if a user is requesting trivia questions for a specific language, in addition to, or alternatively to, generating the trivia questions, the trivia generator 150 can use the language information of the metadata of existing trivia questions to provide the questions to the user. Although some exemplary metadata is discussed above, other data and information can be used for the metadata of the trivia questions.

After the validation controller 303 performs the processing (e.g., one or more of language translation, grammar check, similarity check, re-generation, and/or content ID generation) on the first set of one or more trivia questions and/or their associated additional facts (the language model output 304), the validation controller 303 can generate a second set of one or more trivia questions and/or their associated additional facts. The validation controller 303 can store the second set of one or more trivia questions and/or their associated additional facts with their associated content ID in, for example, storage/buffers 307.

Additionally, or alternatively, the validation controller 303 can output the second set of one or more trivia questions and/or their associated additional facts as output 306b to the UI 305. The second set of one or more trivia questions and/or their associated additional facts can be presented (e.g., displayed) to the user of the UI 305. The user of the UI 305 can use the UI 305 for any further checks and/or revisions of the second set of one or more trivia questions and/or their associated additional facts.

Additionally, or alternatively, the validation controller 303 can output the second set of one or more trivia questions and/or their associated additional facts as output 306a. The output 306a can be displayed on one or more display devices 108 associated with one or more media devices 106 such that the user(s) of the media device(s) 106 can use the media device(s) 106 and/or the remote control(s) 110 to respond to the trivia questions. In some aspects, one user of one media device 106 can use the media device 106 and/or the remote control 110 to answer the trivia questions. In some aspects, a plurality of users of one media device 106 can use the media device 106 and/or the remote control 110 to answer the trivia questions. In some aspects, one user of a plurality of media devices 106 can use the plurality of media devices 106 and/or the plurality of remote controls 110 to answer the trivia questions.

In some aspects, a plurality of users of a plurality of media devices 106 can use the plurality of media devices 106 and/or the plurality of remote controls 110 to answer the trivia questions. For example, multiple users at a watch party for a content can be displayed the trivia questions associated with the content. The users can use their respective media devices 106 and/or remote controls 110 to answer the trivia questions. According to some aspects, the content may be displayed on one display device 108 (e.g., a TV) and the trivia questions may be displayed on the same one display device 108 (e.g., the TV). According to some aspects, the content may be displayed on one display device 108 (e.g., the TV) and the trivia questions may be displayed on a different display device 108 (e.g., a smart phone). In some examples, the users can be in the same physical location. In some examples, the users can be in different physical locations when they view the content and the trivia questions.

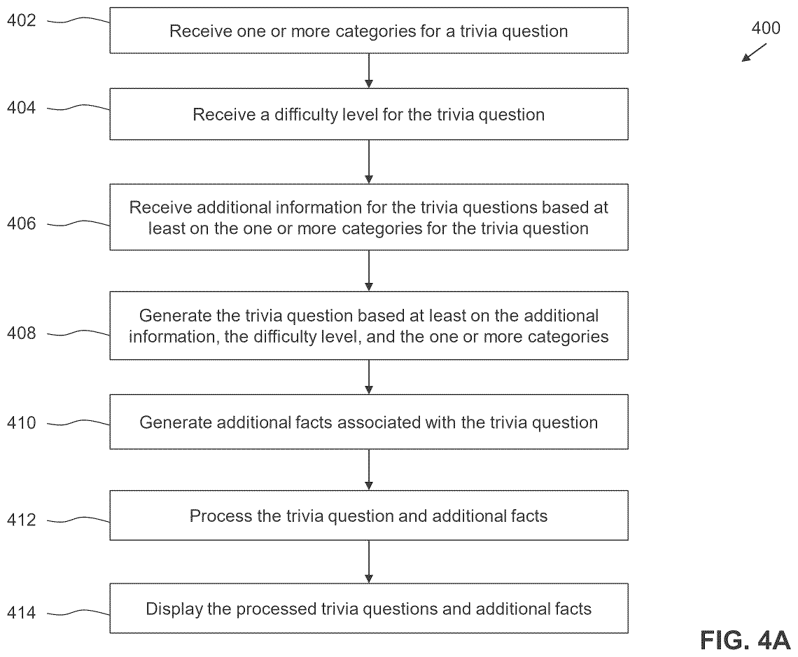

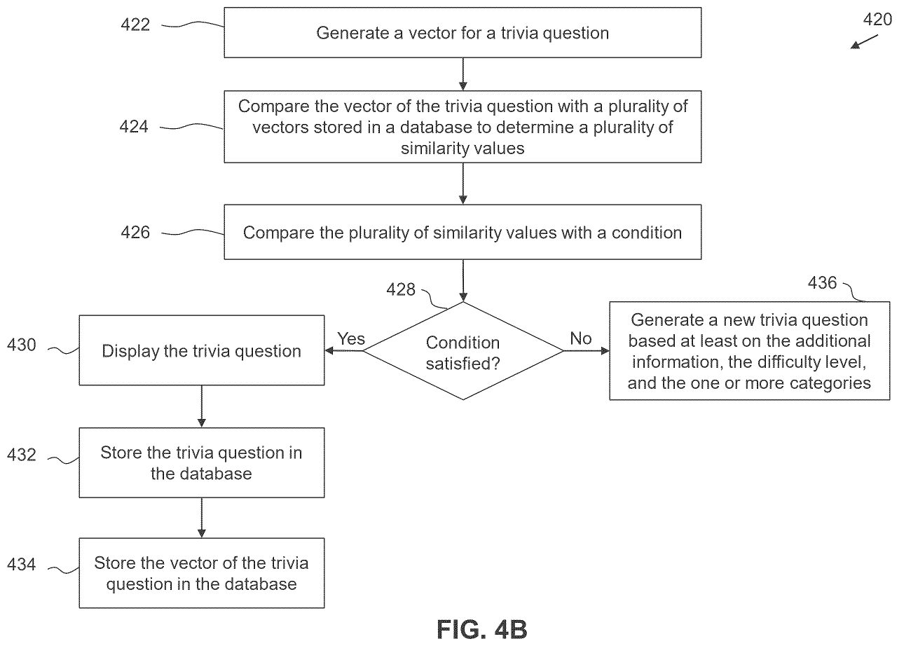

FIG. 4A is a flowchart for a method 400 for generating and displaying trivia questions, according to some aspects. Method 400 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4A, as will be understood by a person of ordinary skill in the art.

Method 400 shall be described with reference to FIGS. 1-3. However, method 400 is not limited to that example aspect. According to some aspects, method 400 can be performed by the trivia generator 150 of FIGS. 1 and 3.

At 402, one or more categories of the trivia question(s) are received. For example, the trivia generator 150 (e.g., the language model 301 of the trivia generator 150) receives the one or more categories for the trivia question(s). According to some aspects, the trivia generator 150 receives the one or more categories as part of the input 302a. In some aspects, the trivia generator 150 can receive the one or more categories from the UI 305 and based on an input provided by a user of the UI 305.

At 404, a difficulty level for the trivia questions are received. For example, the trivia generator 150 (e.g., the language model 301 of the trivia generator 150) receives the difficulty level for the trivia question(s). According to some aspects, the trivia generator 150 receives the difficulty level as part of the input 302a. In some aspects, the trivia generator 150 can receive the difficulty level from the UI 305 and based on an input provided by a user of the UI 305.

As discussed above, in addition to, or alternatively to, the one or more categories and the difficulty level, the trivia generator 150 can receive additional input (e.g., as part of input 302a). For example, the trivia generator 150 can receive a parameter indicating the number of trivia questions to generate. The trivia generator 150 can receive a parameter indicating the type of answers for the trivia question(s). The trivia generator 150 can receive other parameters to be used in generating the trivia questions.

At 406, additional information for the trivia question(s) are received based at least on the one or more categories for the trivia question(s). For example, the trivia generator 150 (e.g., the language model 301 of the trivia generator 150) receives the additional information for the trivia question(s). According to some aspects, the trivia generator 150 receives the additional information as part of the input 302b. The trivia generator 150 can use the one or more categories to retrieve the additional information for the trivia question(s). For example, the trivia generator 150 can access a database that stores the additional information for different content. The trivia generator 150 can send a request to the database. The request can indicate the one or more categories that the trivia generator 150 is looking for. The trivia generator 150 can receive the additional information as input 302b from the database. The trivia generator 150 can use the received additional information for generating the trivia question(s).

At 408, the trivia question(s) are generated based at least on one or more of the additional information, the difficulty level, and the one or more categories. For example, the trivia generator 150 (e.g., the language model 301 of the trivia generator 150) generates one or more trivia questions based at least on the additional information, the difficulty level, and the one or more categories. As discussed above, the trivia generator 150 can use other data to generate the trivia question(s). According to some aspects, the trivia generator 150 uses the additional information retrieve based on the one or more categories to generate the trivia question(s). The trivia generator 150 can use the difficulty level in analyzing and filtering the additional information to generate the trivia question(s). Additionally, or alternatively, the trivia generator 150 can use the difficulty level in generating the answers to the trivia question(s). For example, for a difficulty level of easy and for multiple choice answers, the trivia generator 150 can choose the wrong answers that are clearly different from the correct answer. But, for a difficulty level of hard and for multiple choice answers, the trivia generator 150 can choose the wrong answers that are very close to the correct answer.

At 410, additional facts associated with the trivia question(s) are generated. According to some aspects, operation 410 can be an optional operation. For example, the trivia generator 150 (e.g., the language model 301 of the trivia generator 150) generates additional facts (e.g., fun facts) for the one or more trivia questions based at least on the additional information. According to some aspects, the trivia generator 150 can generate the additional facts using the same database used for generating the trivia question(s) in operation 408. The trivia generator 150 can retrieve and generate the additional facts from the same database used for generating the trivia question(s) in operation 408. Additionally, or alternatively, the trivia generator 150 can generate the additional facts using the other database(s) corresponding to the one or more categories. The trivia generator 150 can retrieve and generate the additional facts from the other database(s). For example, when the additional facts are to be displayed while a content is being displayed on a display device, the trivia generator 150 can retrieve and generate the additional facts from database(s) associated with the content being displayed.

At 412, the trivia question(s) and/or the additional fact(s) are processed. For example, the trivia generator 150 (e.g., the validation controller 303 of the trivia generator 150) further process the generated trivia question(s) and/or the additional fact(s) before they are displayed to a user. According to some aspects, processing the trivia question(s) and/or the additional fact(s) can include one or more of language translation, grammar check, similarity check, re-generation, and/or content ID generation of the trivia question(s) and/or the additional fact(s).

At 414, the processed trivia question(s) and/or additional fact(s) are provided to a user. For example, the trivia generator 150 provides (e.g., displays) the processed trivia question(s) and/or additional fact(s) to one or more users. For example, the processed trivia question(s) and/or additional fact(s) are displayed on one or more display devices 108 associated with one or more media devices 106. According to some aspects, the processed trivia question(s) and/or additional fact(s) are displayed to a user in response to the user's request for the trivia questions. According to some aspects, the user initiates the request when the user is consuming a content and the processed trivia question(s) and/or additional fact(s) are associated with the content.

According to some aspects, the processed trivia question(s) and/or additional fact(s) are displayed to a plurality of users on a plurality of display devices. For example, a plurality of users at the same physical location or at different physical locations (or a combination thereof) are watching the same content on display devices (e.g., TVs) associated with media devices. The plurality of users request trivia questions associated with the content that the users are consuming. The processed trivia question(s) and/or additional fact(s) are provided to the plurality of the user. In some examples, the processed trivia question(s) and/or additional fact(s) are provided to the same display devices (e.g., TVs) the users are using to consume the content. In some examples, the processed trivia question(s) and/or additional fact(s) are provided to different display devices (e.g., the smart phones) of the users. For example, the different display devices (e.g., the smart phones) of the users have an application associated with the media device and/or the trivia generator 150 that are configured to display the processed trivia question(s) and/or additional fact(s).

According to some aspects, method 400 is initiated by the user who wants a set of trivia questions. Additionally, or alternatively, method 400 is initiate by an administrator of the system server 126 and the processed trivia question(s) and/or additional fact(s) are displayed to the user in response to the user's request for the set of trivia questions.

FIG. 4B is a flowchart for a method 420 for processing trivia question(s) and/or additional fact(s), according to some aspects. Method 420 can be performed by processing logic that can include hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 4B, as will be understood by a person of ordinary skill in the art.

Method 420 shall be described with reference to FIGS. 1-4. However, method 420 is not limited to that example aspect. According to some aspects, method 420 can be performed by the trivia generator 150 of FIGS. 1 and 3.

Method 420 is an example of operation 412 of FIG. 4A. The processing of the trivia question(s) and/or the additional fact(s) as discussed with method 420 includes similarity check of the trivia question(s) and/or the additional fact(s). Other exemplary processing of the trivia question(s) and/or the additional fact(s) (e.g., one or more of language translation, grammar check, re-generation, and/or content ID generation) are discussed throughout this disclosure.

At 422, a vector is generated for a trivia question. For example, the trivia generator 150 (e.g., using the validation controller 303 of the trivia generator 150) generates a vector for the trivia question. The trivia generator 150 generates the vector using, for example, a text embedding model. In a non-limiting example, the trivia generator 150 converts the trivia questions (e.g., the trivia question generated in operation 408 of FIG. 4A) to a 3072-dimensional vector to capture the trivia question's semantic meaning. However, other dimension vectors can be used for the conversion.

At 424, the vector of the trivia question is compared with a plurality of vectors stored in a database to determine a plurality of similarity values. For example, the trivia generator 150 (e.g., using the validation controller 303 of the trivia generator 150) compares the vector of the trivia question with a plurality of vectors stored in a database to determine the plurality of similarity values. According to some aspects, the plurality of vectors stored in the database are associated with a plurality of already-generated trivia questions. According to some aspects, comparing the vector of with the plurality of vectors can include comparing each component of the vector with the corresponding component of the plurality of vectors. However, other methods can be used to compare the vector of the trivia question with the plurality of vectors.

Accordingly some aspects, each one of the plurality of similarity values can include an average of differences between each component of the vector of the trivia question with the corresponding component of the corresponding one of the plurality of vectors. Accordingly some aspects, each one of the plurality of similarity values can include a maximum of differences between each component of the vector of the trivia question with the corresponding component of the corresponding one of the plurality of vectors. Accordingly some aspects, each one of the plurality of similarity values can include a minimum of differences between each component of the vector of the trivia question with the corresponding component of the corresponding one of the plurality of vectors. However, the aspects of this disclosure are not limited to these examples, and the plurality of similarity values for the vector of the trivia questions compared to the plurality of vectors stored in the database can be determined using other criteria.

At 426, the plurality of similarity values are compared with a condition. For example, the trivia generator 150 (e.g., using the validation controller 303 of the trivia generator 150) compares the plurality of similarity values with the condition. In some aspects, the condition can include a similarity threshold and the trivia generator 150 is configured to compare each one of the similarity values to the similarity threshold. As discussed above, each similarity value is a result of the comparison between the vector of the trivia question generated in 422 and one of the plurality of vectors stored in the database. By comparing each one of the similarity values with the similarity threshold, the trivia generator 150 can determine how similar the trivia question is to the trivia question associated to the corresponding one of the stored plurality of vectors.

At 428, it is determine whether the condition is satisfied. If the condition is satisfied (e.g., each one of the similarity values is greater than the similarity threshold), the trivia generator 150 can determine that the trivia question is not similar to any of the trivia questions associated to the stored plurality of vectors. In this case, the method 420 moves to operations 430-434. At 430, the trivia question is displayed to the user. At 432, the trivia question is stored in a database. At 434, the vector associated with the trivia question is also stored in the database. In some examples, the same database can be used for the trivia question and the vector associated with the trivia question. In some examples, different databases can be used for the trivia question and the vector associated with the trivia question.

If the condition is not satisfied (e.g., at least one of the similarity values is less than or equal to the similarity threshold), the trivia generator 150 can determine that the trivia question is similar to at least one of the trivia questions associated to the stored plurality of vectors. In this case, the method 420 moves to operation 436. At 436, the trivia question is disregarded and a new trivia question can be generated based at least on the additional information, the difficulty level, and the one or more categories. For example, at 430, operations 408-412 of FIG. 4A can be repeated.

Although method 420 is discussed above with respect to the trivia question, the same method can be applied to the additional facts that are optionally generated in operation 410 of FIG. 4A).

Also, although method 420 is discussed above with respect to one trivia question (or one additional fact associated with the trivia questions), method 420 can be repeated for each trivia question in a plurality of trivia questions. In some aspects, when method 420 is repeated, operation 436 can include disregarding trivia questions that are similar to the trivia questions associated to the stored plurality of vectors but no new trivia question is generated until all of the plurality of trivia questions are evaluated. After the evaluation of all of the plurality of trivia questions is complete, operation 436 can include generating new trivia questions can be generated based at least on the additional information, the difficulty level, and the one or more categories.

### Example Computer System

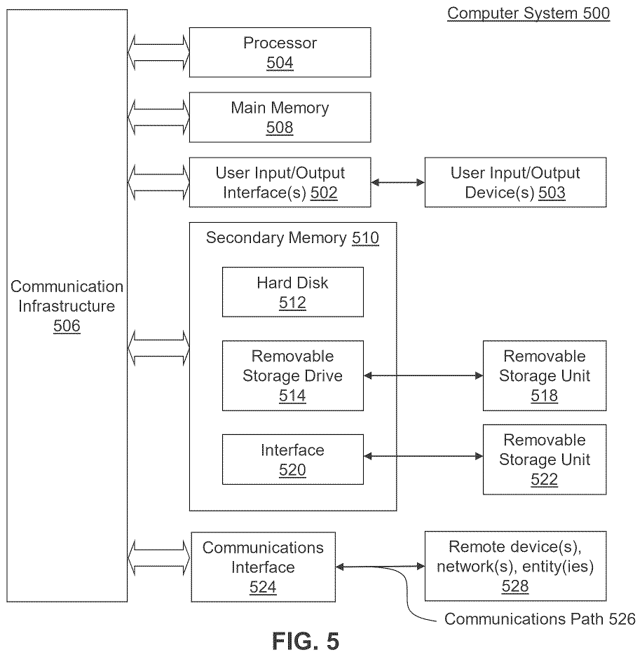

Various aspects may be implemented, for example, using one or more computer systems, such as computer system 500 shown in FIG. 5. For example, the trivia generator 150 may be implemented using combinations or sub-combinations of computer system 500. Additionally, or alternatively, one or more of the language model 301, the validation controller 303, and/or the UI 305 may be implemented using combinations or sub-combinations of computer system 500. Also or alternatively, one or more computer systems 500 may be used, for example, to implement any of the aspects discussed herein, as well as combinations and sub-combinations thereof.

Computer system 500 may include one or more processors (also called central processing units, or CPUs), such as a processor 504. Processor 504 may be connected to a communication infrastructure or bus 506.

Computer system 500 may also include user input/output device(s) 503, such as monitors, keyboards, pointing devices, etc., which may communicate with communication infrastructure 506 through user input/output interface(s) 502.

One or more of processors 504 may be a graphics processing unit (GPU). In an aspect, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main or primary memory 508, such as random access memory (RAM). Main memory 508 may include one or more levels of cache. Main memory 508 may have stored therein control logic (i.e., computer software) and/or data.

Computer system 500 may also include one or more secondary storage devices or memory 510. Secondary memory 510 may include, for example, a hard disk drive 512 and/or a removable storage device or drive 514. Removable storage drive 514 may be a floppy disk drive, a magnetic tape drive, a compact disk drive, an optical storage device, tape backup device, and/or any other storage device/drive.

Removable storage drive 514 may interact with a removable storage unit 518. Removable storage unit 518 may include a computer usable or readable storage device having stored thereon computer software (control logic) and/or data. Removable storage unit 518 may be a floppy disk, magnetic tape, compact disk, DVD, optical storage disk, /d/ any other computer data storage device. Removable storage drive 514 may read from and/or write to removable storage unit 518.

Secondary memory 510 may include other means, devices, components, instrumentalities or other approaches for allowing computer programs and/or other instructions and/or data to be accessed by computer system 500. Such means, devices, components, instrumentalities or other approaches may include, for example, a removable storage unit 522 and an interface 520. Examples of the removable storage unit 522 and the interface 520 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 500 may further include a communication or network interface 524. Communication interface 524 may enable computer system 500 to communicate and interact with any combination of external devices, external networks, external entities, etc. (individually and collectively referenced by reference number 528). For example, communication interface 524 may allow computer system 500 to communicate with external or remote devices 528 over communications path 526, which may be wired and/or wireless (or a combination thereof), and which may include any combination of LANs, WANs, the Internet, etc. Control logic and/or data may be transmitted to and from computer system 500 via communication path 526.

Computer system 500 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 500 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 500 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some aspects, a tangible, non-transitory apparatus or article of manufacture including a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500 or processor(s) 504), may cause such data processing devices to operate as described herein.

Based on the teachings contained in this disclosure, it will be apparent to persons skilled in the relevant art(s) how to make and use aspects of this disclosure using data processing devices, computer systems and/or computer architectures other than that shown in FIG. 5. In particular, aspects can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary aspects as contemplated by the inventor(s), and thus, are not intended to limit this disclosure or the appended claims in any way.

While this disclosure describes exemplary aspects for exemplary fields and applications, it should be understood that the disclosure is not limited thereto. Other aspects and modifications thereto are possible, and are within the scope and spirit of this disclosure. For example, and without limiting the generality of this paragraph, aspects are not limited to the software, hardware, firmware, and/or entities illustrated in the figures and/or described herein. Further, aspects (whether or not explicitly described herein) have significant utility to fields and applications beyond the examples described herein.

Aspects have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative aspects can perform functional blocks, steps, operations, methods, etc. using orderings different than those described herein.

References herein to “one aspect,” “an aspect,” “an example aspect,” or similar phrases, indicate that the aspect described may include a particular feature, structure, or characteristic, but every aspect may not necessarily include the particular feature, structure, or characteristic. Moreover, such phrases are not necessarily referring to the same aspect. Further, when a particular feature, structure, or characteristic is described in connection with an aspect, it would be within the knowledge of persons skilled in the relevant art(s) to incorporate such feature, structure, or characteristic into other aspects whether or not explicitly mentioned or described herein. Additionally, some aspects can be described using the expression “coupled” and “connected” along with their derivatives. These terms are not necessarily intended as synonyms for each other. For example, some aspects can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary aspects, but should be defined only in accordance with the following claims and their equivalents.

What is claimed is:

1. A computer-implemented method, comprising:
receiving, by at least one computer processor, a category for a plurality of trivia questions;
receiving a difficulty level for the plurality of trivia questions;
using the category to retrieve additional information for the plurality of trivia questions;
generating the plurality of trivia questions based at least on the additional information and the difficulty level; and
displaying the plurality of trivia questions on a display device.

2. The computer-implemented method of claim 1, wherein generating the plurality of trivia questions comprises using a large language model (LLM) to generate the plurality of trivia questions based at least on the additional information and the difficulty level.

3. The computer-implemented method of claim 1, further comprising:
sending a request including the category to a database; and
retrieving the additional information from the database in response to the request.

4. The computer-implemented method of claim 1, further comprising:
receiving a first parameter associated with a number of the plurality of trivia questions and a second parameter associated with a type of answers for the plurality of trivia questions,
wherein generating the plurality of trivia questions comprises generating the plurality of trivia questions based at least on the additional information, the difficulty level, the first parameter, and the second parameter.

5. The computer-implemented method of claim 1, further comprising:
generating a content identifier (ID) for the plurality of trivia questions, wherein the content ID is a unique ID to content associated with the generating the plurality of trivia questions.

6. The computer-implemented method of claim 1, further comprising:
processing the plurality of trivia questions before displaying the plurality of trivia questions; and
displaying the processed plurality of trivia questions on the display device.

7. The computer-implemented method of claim 6, wherein processing the plurality of trivia questions comprises at least one of:
translating the plurality of trivia questions from a first language to a second language;
generating additional facts associated with the plurality of trivia questions;
examining a grammar of the plurality of trivia questions; or
generating a content identifier (ID) for the plurality of trivia questions.

8. The computer-implemented method of claim 6, wherein processing the plurality of trivia questions comprises:
generating a vector for a first trivia question of the plurality of trivia questions using a text embedding model;
comparing the vector with a plurality of vectors associated with previously generated trivia questions;
generating a plurality of similarity values based on the comparing; and
comparing each one of the plurality of similarity values with a similarity threshold.

9. The computer-implemented method of claim 8, further comprising:
in response to each one of the plurality of similarity values being greater than the similarity threshold:
displaying the first trivia question of the plurality of trivia questions on the display device; and
storing the vector and the first trivia question of the plurality of trivia questions in a database.

10. The computer-implemented method of claim 8, further comprising:
in response to at least one of the plurality of similarity values being less than or equal to the similarity threshold:
disregarding the first trivia question; and
generating a new trivia question based at least on the additional information and the difficulty level.

11. A non-transitory computer-readable medium having instructions stored thereon that, when executed by at least one computing device, cause the at least one computing device to perform operations comprising:
receiving a category for a plurality of trivia questions;
receiving a difficulty level for the plurality of trivia questions;
using the category to retrieve additional information for the plurality of trivia questions;
generating the plurality of trivia questions based at least on the additional information and the difficulty level; and
displaying the plurality of trivia questions on a display device.

12. The non-transitory computer-readable medium of claim 11, wherein generating the plurality of trivia questions comprises using a large language model (LLM) to generate the plurality of trivia questions based at least on the additional information and the difficulty level.

13. The non-transitory computer-readable medium of claim 11, the operations further comprising:
sending a request including the category to a database; and
retrieving the additional information from the database in response to the request.

14. The non-transitory computer-readable medium of claim 11, wherein the operations further comprising:
receiving a first parameter associated with a number of the plurality of trivia questions and a second parameter associated with a type of answers for the plurality of trivia questions,
wherein generating the plurality of trivia questions comprises generating the plurality of trivia questions based at least on the additional information, the difficulty level, the first parameter, and the second parameter.

15. The non-transitory computer-readable medium of claim 11, the operations further comprising generating a content identifier (ID) for the plurality of trivia questions, wherein the content ID is a unique ID to content associated with the generating the plurality of trivia questions.

16. The non-transitory computer-readable medium of claim 11, the operations further comprising:
processing the plurality of trivia questions before displaying the plurality of trivia questions; and
displaying the processed plurality of trivia questions on the display device.

17. The non-transitory computer-readable medium of claim 16, wherein processing the plurality of trivia questions comprises at least one of:
translating the plurality of trivia questions from a first language to a second language;
generating additional facts associated with the plurality of trivia questions;
examining a grammar of the plurality of trivia questions; or
generating a content identifier (ID) for the plurality of trivia questions.

18. The non-transitory computer-readable medium of claim 16, wherein processing the plurality of trivia questions comprises:
generating a vector for a first trivia question of the plurality of trivia questions using a text embedding model;
comparing the vector with a plurality of vectors associated with previously generated trivia questions;
generating a plurality of similarity values based on the comparing; and
comparing each one of the plurality of similarity values with a similarity threshold.

19. The non-transitory computer-readable medium of claim 18, the operations further comprising:
in response to each one of the plurality of similarity values being greater than the similarity threshold:
displaying the first trivia question of the plurality of trivia questions on the display device; and
storing the vector and the first trivia question of the plurality of trivia questions in a database; and
in response to at least one of the plurality of similarity values being less than or equal to the similarity threshold:
disregarding the first trivia question; and
generating a new trivia question based at least on the additional information and the difficulty level.

20. A system, comprising:
one or more memories; and
at least one processor each coupled to at least one of the one or more memories and configured to perform operations comprising:
receiving a category for a plurality of trivia questions;
receiving a difficulty level for the plurality of trivia questions;
using the category to retrieve additional information for the plurality of trivia questions;
generating the plurality of trivia questions based at least on the additional information and the difficulty level; and
displaying the plurality of trivia questions on a display device.
